(19) United States
(12) Patent Application Publication
(10) Pub. No.: US 2013/0144638 A1
(43) Pub. Date: Jun. 6, 2013

(54) System and Method for Managing Consumer Data

(71) Applicants: Joseph J. O'Connor, Bloomfield Hills, MI (US); Patrick Frenzel, Bloomfield Hills, MI (US); Richard H. May, Birmingham, MI (US)

(72) Inventors: Joseph J. O'Connor, Bloomfield Hills, MI (US); Patrick Frenzel, Bloomfield Hills, MI (US); Richard H. May, Birmingham, MI (US)

(21) Appl. No.: 13/311,918

(22) Filed: Dec. 6, 2011

(51) Int. Cl. G06Q 40/08; G06Q 50/22

(52) U.S. Cl. 705/2

(57) ABSTRACT

A service system for managing consumer data relating to services performed for healthcare consumers by hospitals or healthcare providers over a network. The system includes an insurer computer system that receives and analyzes claims information relating to the services performed. A survey mechanism receives assessment data from the consumers regarding the services received. A central database is in communication with the insurer computer system and the survey mechanism for receiving and storing data regarding the services. A central processor is in communication with the central database, with the central processor configured to analyze the data received from the central database for determining a satisfaction level for each of the consumers regarding the services received, including consumer perceptions of the medical outcome. The service system creates a transactional history of the services received by the consumers for access by the consumers and other authorized interested third parties, such as additional providers.

### FIELD OF THE DISCLOSURE

The present invention relates to a system for managing consumer data and more specifically to a system for measuring composite consumer experiences utilizing billing transaction data.

### BACKGROUND

Service oriented businesses, particularly healthcare services, comprise a series of episodic events. Each of these events are typically performed by one of a plurality of providers for a consumer. There is generally little or no collaboration between the providers and rarely is there any coordination of the services between each of the providers. Consumers of the services may be forced to endure repeated performance of the same service unnecessarily, where one of the providers could have merely reviewed the data resulting from another provider's service. Accordingly, costs of these services are unnecessarily increased due to the repeated performance. Further, the consumer may have an unfavorable and/or an unsatisfactory outcome from the services due to this lack of collaboration between the providers.

Many attempts have been made in the art to improve upon collection, organization, and accuracy of data related to services performed for the consumers by the providers, particularly to services performed for healthcare consumers. Generally, each healthcare organization is a member of a healthcare network. Each healthcare network collects, organizes, and updates information regarding the consumers that receive services within that particular network. As long as a particular consumer remains within that particular healthcare network, the data regarding the services performed for the particular consumer may be substantially complete and accurate. Although in many instances even within a particular hospital network, this information may be incomplete. However, if the consumer chooses to receive services from multiple hospitals or healthcare networks and/or if the consumer changes health insurance providers, the consumer may be forced to change hospitals or healthcare networks. Ensuring that data is updated and accurate across multiple healthcare networks has proven to be difficult to manage because there are so many sources from which data is obtained, and some healthcare networks will not even receive and/or store the data due to liability concerns and other reasons. Therefore, there remains an opportunity in the art for an improved system for obtaining, organizing, and updating consumer data related to services performed by provides for consumers, particularly where collaboration and engaging consumers determines value.

### SUMMARY

The present disclosure provides for a service system of managing consumer data relating to services performed for a plurality of healthcare consumers by a plurality of hospitals or healthcare providers. The consumer data is managed over a computer network. An insurer computer system is in communication with the computer network for receiving and analyzing claims information relating to the services performed by the hospitals or healthcare providers. A survey mechanism allows the healthcare consumers to provide assessment regarding the services received from the hospitals or healthcare providers. A central system includes a central database and a central processor in communication with the central database. The central database is in communication with the insurer computer system and the survey mechanism via the computer network for receiving and storing data regarding the services performed by the hospitals or healthcare providers. The central processor is in communication with the central database and the central processor is configured to analyze the data received from the central database to determine a satisfaction level for each of the healthcare consumers regarding the services received from the hospital or healthcare provider. The service system provides a transactional history of the services received by the healthcare consumers that is generated by the central processor and is stored on the central database for access by the healthcare consumers. The present disclosure also provides a method of managing consumer data relating to services performed for a plurality of healthcare consumers by a plurality of hospitals or healthcare providers which engage the consumers to determine value and is a collaborative effort between the consumers and the providers. This service system will deliver requirements of feedback from consumers. Data is used from a filtered, single payment source which is very trustworthy, dynamic, and as complete as billing and payment systems allow. The event and the provider are known within the billing cycle. Any responses will be factual and dynamic in a real time continuous development reporting system. As the billing systems improve, so will the data. This allows reports and reporting to be generated to hospitals, healthcare providers, and other payors while fresh in a patient's mind.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is a flow chart illustrating a service system for managing consumer data via a network;

FIG. 2 is a flow chart illustrating interaction between a plurality of consumers and a plurality of providers;

FIG. 3 is a flow chart illustrating interaction between the providers and an insurer computer system;

FIG. 4 is a flow chart illustrating interaction between the insurer computer system and a central system via the network and interaction between the consumers and the central system via a survey mechanism; and

FIG. 5 is a flow chart illustrating the providers receiving feedback from the central system.

### DETAILED DESCRIPTION

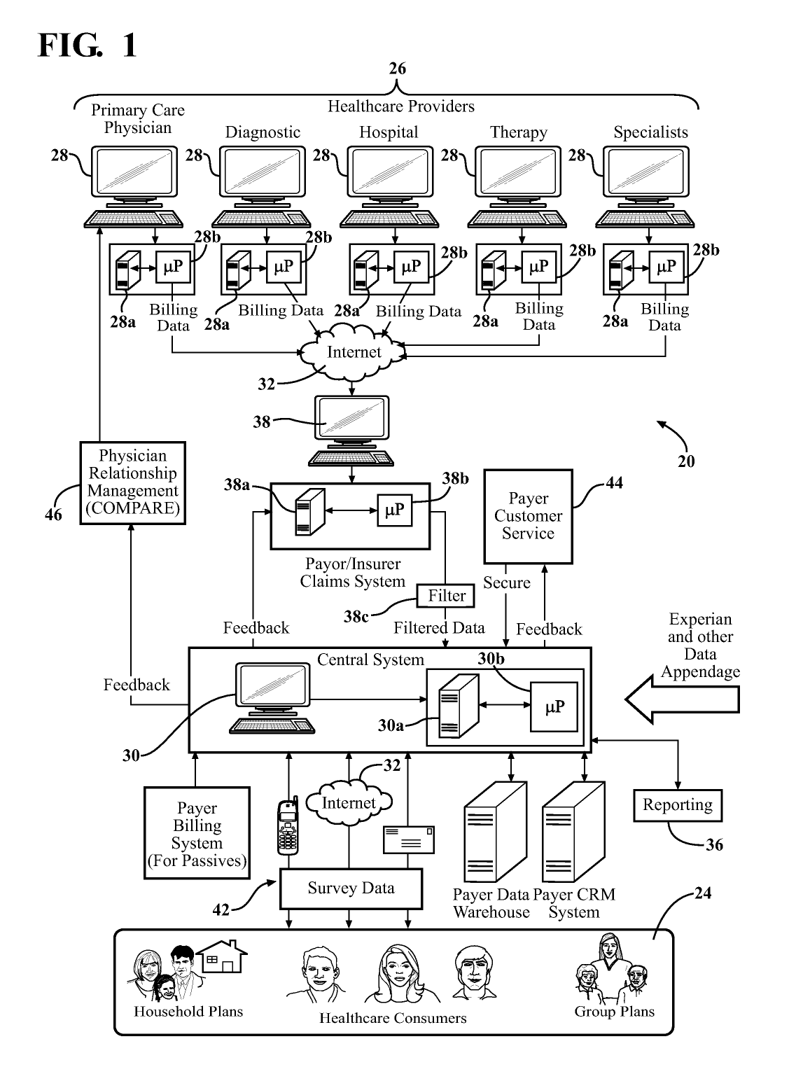

Referring to the Figures wherein like numerals indicate like or corresponding parts, a service system of managing consumer data is generally shown at 20 in FIG. 1.

The service system 20 relates to services 22 performed for a plurality of consumers 24 by a plurality of providers 26 and a collaborative method of evaluating satisfaction of the consumers 24 who receive the services 22. For illustrative purposes only, the service system 20 will be described in connection with healthcare and healthcare services 22. Typically, the providers 26 include: physicians, specialists, hospitals, nursing homes, therapists, pharmacists, pharmaceutical companies, and other healthcare providers. However, those skilled in the art will appreciate that the service system 20 may be utilized in other types of service oriented industries without deviating from the scope of the present disclosure. Therefore, it is to be appreciated that the service system 20 of the present disclosure may be employed in a variety of settings and is not necessarily limited to consumers 24 and providers 26 of healthcare services 22.

Typically, before any services 22 are performed by the providers 26, the consumers 24 will be asked to complete a consumer profile. The consumer profile includes basic information to identify each of the consumers 24. The basic information typically includes the name, address, phone number, gender, date of birth, and other similar types of information for each of the consumers 24. Additionally, the providers 26 may ask each of the consumers 24 to supply demographic data. Demographic data may include information such as race, education, whether they have children, household income, etc. Further, if the services 22 sought are related to healthcare, the provider may ask the consumer to supply information about their medical history, particularly historical medical information related to the services 22 sought. Each of the consumers 24 will typically have to supply the above information to each of the providers 26 from which the consumers 24 seek services 22.

Requiring each of the consumers 24 to repeatedly supply the above information is not desirable. Repeatedly supplying this type of information is cumbersome and time consuming. Additionally, each time a new set of information is given to one of the providers 26, there is an opportunity for error. The consumers 24 may make mistakes when filing out the information request, or the consumers 24 may omit important information. Alternatively, the providers 26 may make an error entering the supplied information into a provider computer system 28.

The present disclosure is advantageous because it uses data from a central system 30 for storing, organizing, and analyzing the consumer data and to help ensure accuracy and completeness of the information for each of the consumers 24. The data that is generated in such a system has filtered data that has not been utilized in the manner described below, and, as a part of this system, creates a novel and nonobvious usefulness and advantage when employed in the manner described below that has not been previously recognized in the art.

The service system 20 of the present disclosure includes a network 32, which is preferably a computer network 32. The computer network 32 enables communication between a plurality of databases and processors. In other words, the processors are configured to transmit and receive data located on the respective databases between one another over the computer network 32. Preferably, the computer network 32 includes the World Wide Web (the Internet). However, the computer network 32 is not limited to the Internet and may be a smaller scale computer network, such as a local area network, as long as it is capable of performing the functions discussed hereinafter and includes the data as described herein. Additionally, the computer network 32 may comprise a plurality of local area networks communicating in a manner coupled to one another over the Internet or via some other mechanism.

The service system 20 may also include firewalls 34. Often, the data on the service system 20 is personal and private to the consumers 24, especially when the data pertains to the medical records. The firewalls 34 can help protect data located on the service system 20 by preventing unauthorized users from accessing the data. Typically each of the consumers 24 have unique credentials for accessing the data protected by the firewalls 34. The unique credentials typically include a user name or log-in name and a password. With regard to healthcare data, the privacy and security of the data is regulated by the Healthcare Insurance Portability and Accountability Act (HIPAA). The service system 20 of the present disclosure complies with HIPAA regulations.

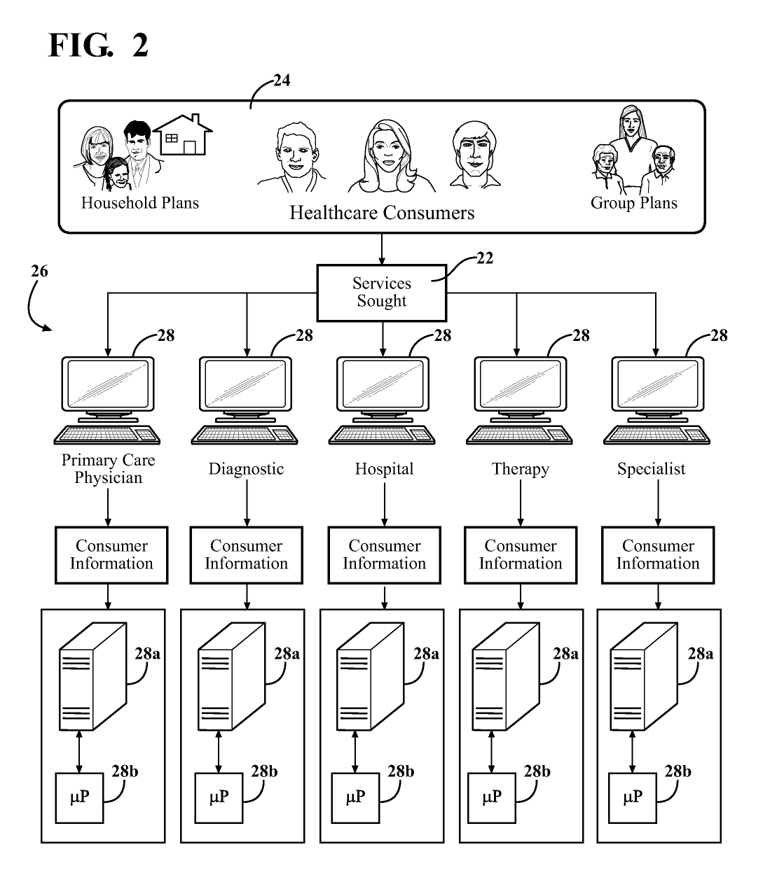

With reference to FIG. 2, each of the providers 26 utilizing the service system 20 of the present disclosure typically has access to the provider computer system 28. Each of the provider computer systems 28 generally includes a provider database 28a and a provider processor 28b in communication with the provider database 28b. The provider processor 28b may pull data from the provider database 28a, and the provider processor 28b may also send data to the provider database 28a. The provider database 28a typically stores the data supplied by the consumers 24 as described above. Specifically, the provider database 28a stores the basic information and the demographic information supplied by each of the consumers 24 seeking services 22 from the providers 26. Additionally, each provider database 28a stores a plurality of procedural codes and information related to the services 22 performed for each of the consumers 24 by the providers 26. The provider database 28a may also contain information from other providers within a network of the providers' 26 or from other providers with whom the providers 26 are otherwise associated. However, the provider database 28a is generally limited to the information provided by the consumers 24 and may not, and typically does not, contain an accurate medical history for the consumers 24. The consumers 24 may intentionally not include some information due to embarrassment and/or because the consumers 24 may think the information is not relevant to the services 22 sought. Additionally, the consumers 24 may simply forget to include certain information. Without an accurate medical history for the consumers 24, a treatment regimen may be adversely affected, such that the regimen is not effective, or makes the condition for which the services 22 are sought worse. The providers 26 may have chosen a different treatment path/regimen altogether if the missing information were known by the providers 26.

The provider processor 28b is in communication with the provider database 28a. The provider processor 28b typically applies a unique identifier for each of the consumers 24 within the provider database 28a. The procedural codes are predetermined codes which are associated with each of the services 22 performed by the providers 26. Preferably, the predetermined codes utilized are a standardized coding methodology such as the International Statistical Classification of Diseases and Related Health Problems (ICD). LCD codes are alphanumeric designations given to description of symptoms, complaints, externa' causes of injury or disease, diagnosis, and cause of death attributed to human beings. The ICD codes are maintained and periodically updated by the World Health Organization, Currently, at the time this application is being drafted, revision nine (ICD-9) is the standard used in the United States (U.S.). Revision 10 (ICD-10) is scheduled to be adopted as the standard in the U.S. in 2013. For example, ICD-10 allows for more than 14,400 different codes to describe diseases, diagnoses, etc. and by utilizing sub-classifications, the number of codes may be expanded to cover over 16,000 descriptions. Utilizing the standardized coding system, specifically the ICD codes, is preferred because it allows the providers 26 to consistently identify and accurately report each diagnosis and description of symptoms to the service system 20. Consistent and accurate data related to each of the services 22 is important for evaluating outcomes of the services 22 performed by the providers 26 and ultimately determining a satisfaction level of each of the consumers 24 in the service system 20. It is to be appreciated that alternative classification systems may also be utilized without deviating from the scope of this disclosure. The provider processor 28b links the identifier for each of the consumers 24 with the each of the predetermined codes associated with the services 22 performed for the consumers 24 to create transaction data for each of the consumers 24.

The transaction data is typically used to submit a claim to an insurer so that the providers 26 are paid for the services 22 performed for the consumers 24. It is to be appreciated that the term “insurer” may also include other payor entities such as, but not limited to, federal and state employee programs, Medicare, Medicaid, Veterans Health Administration, Military Health Systems, and other similar entities.

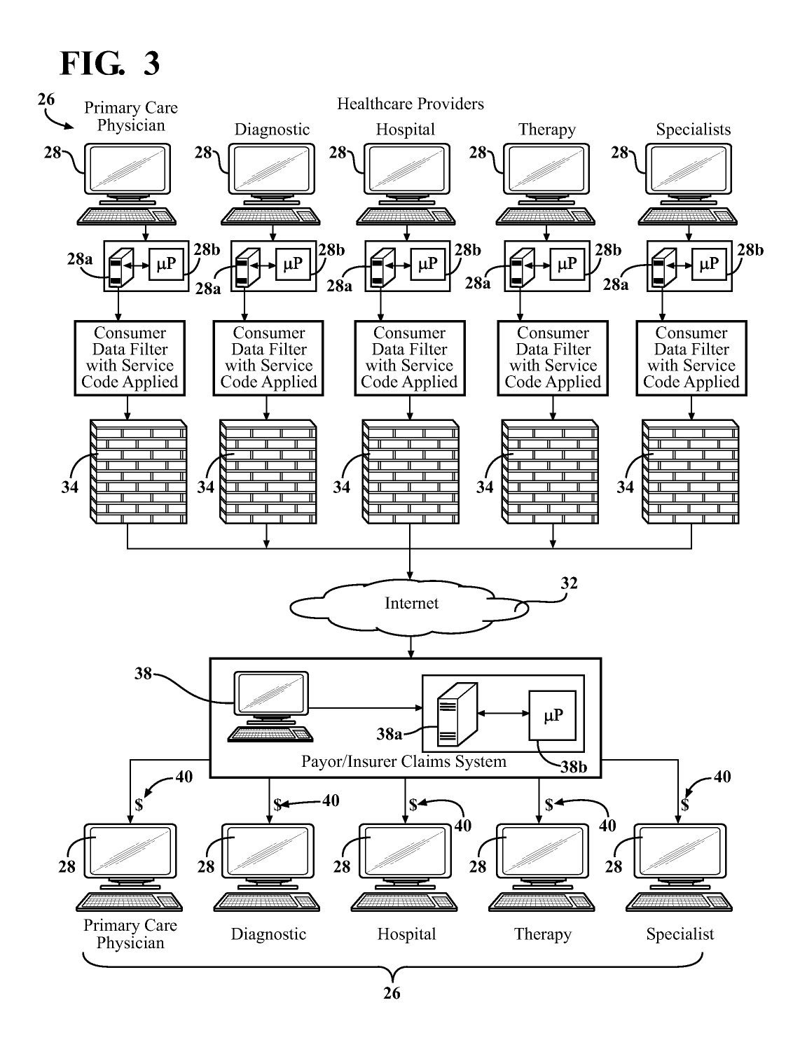

With additional reference to FIG. 3, each insurer participating in the service system 20 typically has an insurer computer system 38. The insurer computer system 38 includes a claims database 38a in communication with each provider computer system 28 via the computer network 32 for receiving the transaction data from the provider computer system 28. The claims database 38a stores the transaction data thereby creating a set of historical data for each of the consumers 24. The insurer computer system 38 further includes a claims processor 38b in communication with the claims database 38a for analyzing the transaction data and processing a payment 40 to the providers 26 for the services 22 performed for the consumers 24. It is to be appreciated that the claims processor 38b may pull data from the claims database 38a, and the claims processor 38b may also send data to the claims database 38a.

Each insurer computer system 38 may further includes a filtering mechanism 38c. The filtering mechanism 38c is in communication with the insurer computer system 38, specifically with the claims processor 38b for analyzing and comparing the transaction data with historical data in the claims database 38a. If there is a discrepancy between the transaction data and the historical data, the filtering mechanism 38c will alert the insurer of the discrepancy. For example, if the transaction data has an address of “123 Main Street” for one of the consumers 24 and the historical data has an address of “132 Main Street” for the same consumer 24, the filtering mechanism 38c will alert the insurer so that the information may be corrected and/or updated to reflect accurate information thereby creating updated data. Additionally, the filtering mechanism 38c may be configured to correct the information automatically for creating the updated data for placement into the claims database 38a. The filtering mechanism 38c is configured to organize and filter the information from the insurer computer system 38 according to predetermined criteria, thereby creating filtered data. The filtered data from insurer computer system 38 is preferred for the service system 20 because, after being filtered, the data is substantially accurate and is updated regularly. Said differently, the filtered data from the insurer computer system 38 is the single best source for dynamically updated and accurate data for use in the service system 20.

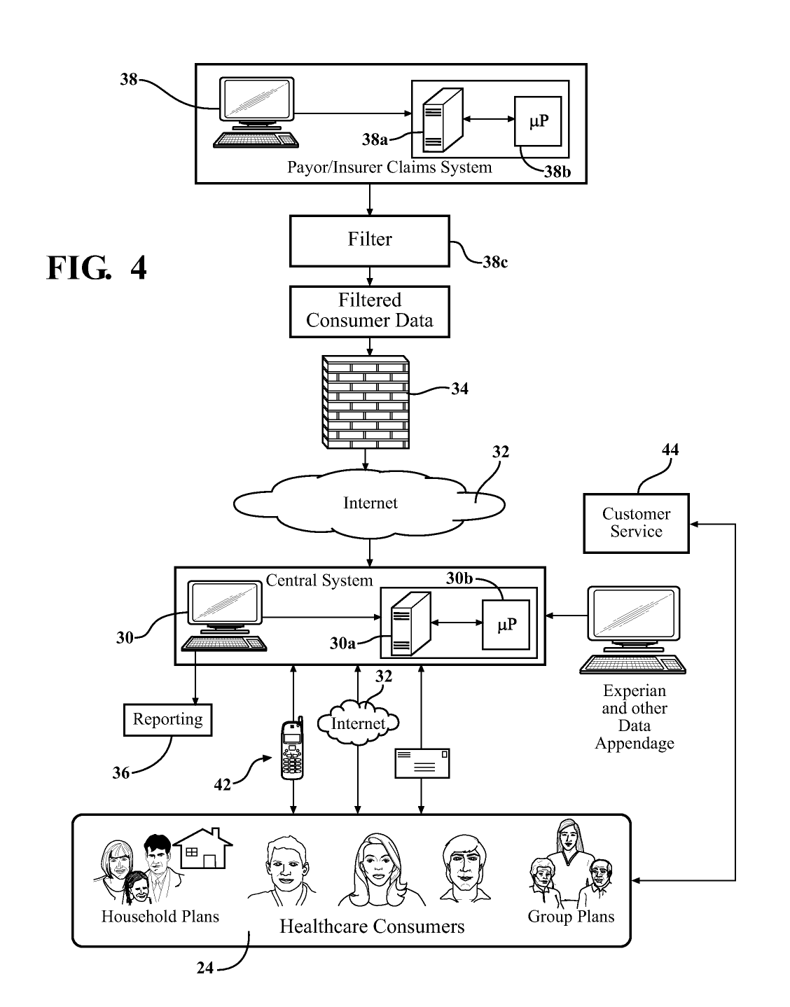

With reference to FIG. 4, the service system 20 of the present disclosure also provides a survey mechanism 42. The survey mechanism 42 enables consumers 24 to rate the services 22 received from the providers 26 thereby providing assessment data from the consumers 24. The survey mechanism 42 may be configured to capture a plurality of experience information that is not included in the transaction data, as described above. Each of the consumers 24 are typically able to provide feedback based upon their perception of the services 22 they received from each of the providers 26 and the outcome of those services 22. The experience information may also include information such as how the consumers 24 were greeted by the providers 26, the cleanliness of the provider's facility, ease of finding the provider's facility, recommendations for improvement, how information was communicated to the consumers 24, and most importantly, the consumers' 24 perception of the medical outcome. It is to be appreciated the additional types of experience information may also be provided through the survey mechanism 42. The survey mechanism 42 may include consumer panels, web based surveys, telephone surveys, printed surveys, in-person interviews, integrated surveys in call centers, focus groups, and the like. Typically, the survey mechanism 42 is utilized a short time after the services 22 are completed and any experiences related to the services 22 are fresh in the mind of each of the consumers 24.

The central system 30 comprises a central database 30a and a central processor 30b in communication with the central database 30a. The central system 30, specifically the central database 30a, is typically in communication with the insurer computer system 38 for receiving and storing the updated data from each filter mechanism 38c. The central database 30a also receives and stores the consumer assessment data from the survey mechanism 42 via the computer network 32. The central processor 30b is in communication with the central database 30a and is configured to analyze the updated data and the assessment data for determining a satisfaction level for each of the consumers 24 with the services 22 received from the providers 26. The service system 20 may further include a customer service unit 44 in communication with the central system 30 for obtaining and analyzing additional feedback from the consumers 24. The central system 30 may also provide feedback to the insurer computer system 38. The feedback provided by the central system 30 may help to evaluate the services 22 provided by the providers 26 for promoting enhanced overall experiences for the consumers 24. The service system 20 engages the consumers 24 to determine the overall “value” of the services 22 performed by the providers 26. The voice of the consumers 24, through the service system 20, becomes a consistent metric for evaluating the providers 26 and thereby managing the level of care received through the services 22, the outcome of those services 22, avoidance of duplication of services 22, and containing costs associated with the services 22.

Additionally, the central system 30 may include a reporting mechanism 36. The reporting mechanism 36 may be configured to generate a report on a plurality of data sets as described above and any combination thereof. For example, the reporting mechanism 36 may be utilized to generate a report on an individual consumer or on a group of consumers based on some predetermine criteria. Additionally, the reporting mechanism 36 may generate reports on individual or groups of providers and individual or groups of facilities. The reports generated may be based upon geographical locations, demographic information, life style identifiers, or any other data in the central database 30a. The reporting mechanism 36 of the service system 20 is able to generate individualized reports that include an aggregate of information that is dynamically updated faster and more accurately than other systems currently know in the art.

The central system 30 allows for the development of an accurate chronicle of transactional history for each of the consumers 24 that can be accessed by various providers 26, the consumers 24, or any authorized third party. The transactional history may include a listing of procedures, the date each procedure was performed, and the provider who performed the procedure. Typically, the transactional history will not include the actual procedure results, such as x-ray films, ultrasonic images, or a complete blood count (CBC) report. However, the transactional history will typically include a diagnosis resulting from interpretation of the procedure results. With all of the consumer data in the central system 30, the individual consumers 24 and any authorized third party, including authorized providers, may access the transactional history of services 22 performed for each of the consumers 24. As an example, one of the consumers 24 can provide access to their complete medical transactional history, by merely giving access to the central system 30 with their unique credentials, without having to supply the same information repeatedly to numerous hospitals or healthcare providers 26. Yet another advantage to the system 20 of the present disclosure is that the consumers 24 may be able to avoid having the same type of services 22 performed by various providers 26, e.g. blood work or x-rays, thereby saving time, costs, and pain to the consumers 24.

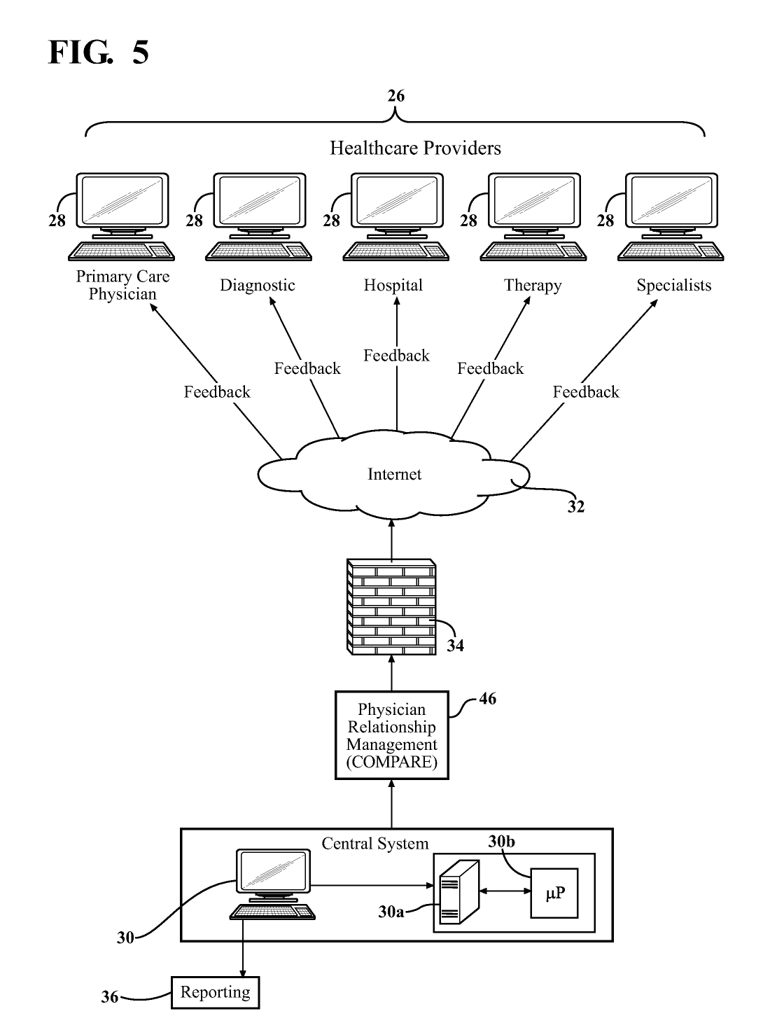

With reference to FIG. 5, the service system 20 may also include an assessment system 46 in communication with the central system 30. The assessment system 46 provides feedback to the providers 26 via the computer network 32. Typically there is a firewall 34 between the assessment system 46 and the providers 26 for protecting the data from unauthorized access.

The present disclosure also contemplates a method for managing consumer data relating to services 22 performed for a plurality of consumers 24 by a plurality of providers 26. The method includes the step of providing a network 32, preferably a computer network. The method may further include the step of providing an insurer computer system 38 in communication with the computer network 32 for receiving and analyzing claims information relating to the services 22 performed and processing payments 40 to the hospitals or healthcare providers 26 performing the services 22. The method may further include the step of providing a survey mechanism 42 for receiving assessment from the healthcare consumers 24 regarding the services 22 received from the hospitals or healthcare providers 26. The method may further include the step of providing a central database 30a in communication with the insurer or payor's computer system 38 and the survey mechanism 42 via the computer network 32 for receiving and storing data regarding the services 22 performed by the hospitals or healthcare providers 26. The method may further include the step of providing a central processor 30b in communication with the central database 30a with the central processor 30b configured to analyze the data received from the central database 30a for determining a satisfaction level for each of the healthcare consumers 24 regarding the services 22 received from the hospitals or healthcare providers 26. The method may further include the step of maintaining a chronicle of medical transactions. The method may further include the step of providing a report generating mechanism for generating reports pertaining to the services 22 performed. The method may further include the step of providing a customer service unit 44 for obtaining additional feedback from the healthcare consumers 24.

The present disclosure has been described in an illustrative manner, and it is to be understood that the terminology which as been used in intended to be in the nature of words of description rather than of limitation. Obviously, many modifications and variations of the present disclosure are possible in light of the above teachings. The disclosure may be practiced otherwise than as specifically described within the scope of the appended claims.

What is claimed is:

1. A service system of managing consumer data relating to services performed by a plurality of healthcare providers for a plurality of healthcare consumers, said system comprising:
a computer network;
an insurer computer system configured to generate claims information relating to the services performed by the healthcare providers;a survey mechanism for receiving assessment from the healthcare consumers regarding the services received from the healthcare providers;
a filtering mechanism in communication with said insurer computer system and configured to organize and filter said claims information according to predetermined criteria for creating filtered data;
a central system in communication with said filtering mechanism via said computer network and configured to receive and store said filtered data with said central system comprising;
a central database in communication with said insurer computer system and said survey mechanism via said computer network for receiving and storing data regarding the services performed by the healthcare providers;
a central processor in communication with said central database with said central processor configured to analyze said data received from said central database for determining a satisfaction level for each of the healthcare consumers regarding the services received from the healthcare provider; and
wherein said central system creates a transactional history of the services received by the healthcare consumers accessible by the healthcare consumers and authorized third parties.

2. The system as set forth in claim 1 wherein each of the healthcare consumers has unique credentials for accessing said transactional history.

3. The system as set forth in claim 1 further including a provider database for storing data related to each of the healthcare consumers and the services provided for the healthcare consumers.

4. The system as set forth in claim 3 further including a provider processor in communication with said provider database wherein said provider processor applies an identifier for each of the healthcare consumers and associates a predetermined code with each of the services performed by the healthcare provider and linking said predetermined code with said identifier thereby creating transaction data.

5. The system as set forth in claim 4 wherein said insurer computer system comprises a claims database in communication with said provider processor via said computer network for receiving said transaction data and wherein said insurer computer system further comprises a claims processor in communication with claims database for analyzing said transaction data for processing payments to the healthcare providers performing the services

6. The system as set forth in claim 1 further including a report generating mechanism for generating reports pertaining to a specified group associated with said system.

7. The system as set forth in claim 6 wherein said report generating mechanism creates reports about each of the consumers receiving the services.

8. The system as set forth in claim 6 wherein said report generating mechanism creates reports about each of the providers performing the services.

9. The system as set forth in claim 6 wherein said report generating mechanism creates reports about any individual or group associated with the services performed.

10. The system as set forth in claim 1 further including a customer service unit for obtaining feedback from said consumers with said customer service unit in communication with said central system for organizing and analyzing the feedback from said consumers.

11. The system as set forth in claim 10 wherein said central database provides feedback to said customer service unit.

12. The system as set forth in claim 1 wherein said central processor provides feedback to the plurality of providers regarding patient satisfaction and resulting medical outcome from the patient's perspective.

13. The system as set forth in claim 1 wherein said survey mechanism is conducted over the internet.

14. The system as set forth in claim 1 wherein said survey mechanism is conducted through a telephone interview.

15. The system as set forth in claim 1 wherein said survey mechanism is conducted through the mail.

16. A method of managing consumer data relating to services performed for a plurality of healthcare consumers by a plurality of healthcare providers, said method comprising the steps:
providing computer network;
providing a insurer computer system in communication with said computer network for receiving and analyzing claims information relating to the services performed and processing payments to the healthcare providers performing the services;
providing a survey mechanism for receiving assessment from the healthcare consumers regarding the services received from the healthcare providers;
providing a central database in communication with said insurer computer system and said survey mechanism via said computer network for receiving and storing data regarding the services performed by the healthcare providers; and
providing a central processor in communication with said central database with said central processor configured to analyze said data received from said central database for determining a satisfaction level for each of the healthcare consumers regarding the services received from the healthcare providers.

17. The method as set forth in claim 16 further including the step of maintaining a chronicle of medical transactions.

18. The method as set forth in claim 16 further including the step of providing a report generating mechanism for generating reports pertaining to the services performed.

19. The method as set forth in claim 16 further including the step of providing a customer service unit for obtaining additional feedback from the healthcare consumers.

20. A system of managing consumer data relating to services performed by a plurality of healthcare providers for a plurality of healthcare consumers, said system comprising:
a computer network;
an insurer computer system configured to generate claims information relating to the services performed by the healthcare providers;
a filtering mechanism in communication with said insurer computer system and configured to organize and filter said claims information according to predetermined criteria for creating filtered data; and
a central system in communication with said filtering mechanism via said computer network with said central system configured to receive and store said filtered data;
wherein said central system utilizes said filtered data to develop and manage individual health history and ongoing wellness plans for each of the healthcare consumers thereby measuring satisfaction of said healthcare consumers relating to the services received from the healthcare providers.
